(19) United States
(12) Patent Application Publication
(10) Pub. No.: US 2008/0118591 A1
(43) Pub. Date: May 22, 2008

(54) Bactericidal Formulations

(76) Inventor: Andreas Natsch, Uetikon (CH)

Correspondence Address: NORRIS, MCLAUGHLIN & MARCUS, 875 THIRD AVE, 18TH FLOOR, NEW YORK, NY, 10022, US

(21) Appl. No.: 11/719,261

(22) PCT Filed: Nov. 15, 2005
(86) PCT No.: PCT/CH05/00676

§ 371 Date: Jul. 31, 2007

(30) Foreign Application Priority Data
Nov. 17, 2004 (GB) 0425305.0

(51) Int. Cl. A01N 31/00; A01N 35/00; A01N 43/42; A01N 43/16; A01N 43/08; A01N 65/00; A01N 41/10; A01N 29/04; A01P 1/00

(52) U.S. Cl. 424/774; 514/739; 514/724; 514/729; 514/731; 514/690; 514/311; 514/738; 514/460; 514/473; 424/778; 514/693; 514/699; 514/709; 514/751; 424/725

(57) ABSTRACT

The invention relates to bactericidal formulations that come into contact with human body, particularly wash formulations including liquid soaps, comprising perfume ingredients active against gram-negative bacteria. Such compositions contact the target site, for example the skin surface, only for a short time, usually not longer than 30 seconds. Therefore the antibacterial action has to be of the bactericidal type and rapid. Furthermore, the bactericidal activity has to be sufficiently high to ensure an effect even when applied to wet substrates that will dilute the bactericidal formulation.

The present invention is directed to bactericidal formulations containing perfume ingredients that have a rapid bactericidal effect on one or more gram-negative bacteria, and bactericidal perfume compositions for such formulations. Further, the present invention is directed to formulations that, in addition, contain an active ingredient against gram-positive bacteria, for example low concentrations of Triclosan or other phenolic biocides, to provide a broadband action covering both gram-positive and gram-negative bacteria even at a reduced concentration of Triclosan.

Antibacterial formulations that are brought into contact with the human skin, particularly hand washing formulations such as liquid soaps, contact the target site (for example the skin surface or inert surfaces to be disinfected by wiping) only for a short time, usually not longer than 30 seconds. Therefore the antibacterial action has to be rapid. Furthermore, the antibacterial activity has to be sufficiently high to ensure an effect even when applied in diluted form. Antibacterial agents may be bacteriostatic (inhibiting bacterial growth but not killing bacteria present) or bactericidal (killing bacteria). For a fast-acting wash formulation that kills bacteria within the usual time of its application, for example during washing of the hands, a rapid bactericidal effect that kills bacteria within 30 seconds is needed.

Many antibacterial agents have disadvantages that preclude them from use in consumer products such as personal care formulations. For example, they may be detrimental, allergenic, irritating or aggressive to the human skin, or they may not be compatible with other ingredients in the same formulations.

Known antibacterials include surfactants, lower molecular weight aldehydes such as glutaraldehyde, mono- or polyhydric solvents, for example ethanol or isopropanol, and oxidising agents such as hypochlorite and hydrogen peroxide. Surfactants in high concentration provide a bacteriostatic effect, which is suitable for longer exposure times such as in dishwashing liquids (e.g. to apply in undiluted form to treat dishes). However, high concentrations of surfactants can have a detrimental effect on the skin. Cationic surfactants are fast-acting antibacterials, but they are incompatible with anionic surfactants, soap acids and amphoteric surfactants. However, these components are needed to obtain a cosmetically-acceptable wash formulation with a good cleaning ability for application to the skin. Lower molecular weight aldehydes, particularly glutaraldehydes, have the disadvantage of being allergenic and/or irritating to the human skin. Mono- or polyhydric solvents, for example ethanol or isopropanol, need to be present in a large amount of 30 to 70% of the total composition to provide a sufficient antibacterial effect, in which concentration they dry out the skin, making it more susceptible to bacterial attack. Oxidising agents such as hypochlorite and hydrogen peroxide are aggressive agents that damage the human skin at the concentrations needed for antibacterial action.

Known antibacterials that are milder on the human skin and compatible with many cosmetic formulations are phenolic antibacterials such as chlorinated compounds. A widely used example is 2,4,4′-trichloro-2′-hydroxy-diphenylether (commonly known as Triclosan). These compounds have a broadband bactericidal effect at least in higher concentrations and are sufficiently fast-acting for application to human skin, e.g. hand washing formulations. However, these phenolic compounds have been criticised for their negative impact on the environment and for a possible accumulation of bacterial resistance upon usage. It is therefore desirable to reduce their concentration in consumer and personal care products. Further, their efficacy on gram-negative bacteria is limited, particularly at low concentrations of about 0.3%. However, many problematic bacteria transferred by hand and skin contact are gram-negative, these include for example Salmonella sp., Escherichia coli, Pseudomonas aeruginosa, Pseudomonas fluorescens, Klebsiella pneumoniae, and Serratia marcescens.

WO 00/78141 discloses antibacterial compositions containing low levels of Triclosan. These compositions rely on the combination of surfactant, hydrotrope and polyhydric solvent as essential ingredients to provide a broad spectrum fast-acting efficient antibacterial activity. They are rapidly effective against bacteria including gram-negative bacteria when applied in undiluted form. However, some formulations such as hand washing formulations or other cleaning or disinfecting formulations are usually applied in diluted form, e.g. on wet hands/surfaces or with added water.

Some perfume ingredients have been described as having an antimicrobial effect. These include, in particular, essential oils or essences containing many substances, but also some active compounds including thymol and geraniol. The combination of unsaturated aliphatic terpene alcohol(s), in particular geraniol, with certain hydrotropes in formulations with a high surfactant content (at least 10%, exemplified concentrations are much higher) is known to be of use in dishwashing formulations, which are applied to dishes over long exposure times, provides an antibacterial effect, as described in EP 0 855 439 and EP 0855 440.

The antimicrobial effects of perfume ingredients are generally considered weak, compare for example U.S. Pat. No. 6,479,456. This document discloses compositions comprising perfume ingredients and certain synergistic components, e.g. fumaric acid, to achieve a higher activity. Particularly disclosed are perfume ingredients at concentrations of 0.5% in a shampoo which are active against P. ovale, a fungal species associated with dandruff, and various products with multi-ingredient perfume compositions in a concentration of 1 or 1.5%. The disclosed test method for antibacterial activity allows for continued activity of deposited ingredients over incubation periods of 3 times 24 h, each following exposure times of 30 seconds during which the concentrated product is applied to the agar, afterwards rinsed off with water and incubated with any residual actives present on or in the agar.

Pine oil has been used as an active against both gram positive and gram negative bacteria in surface disinfectants (WO 98/02044).

Certain essential oils (for example from thyme, lemongrass, lemon, orange, anise, clove, rose, levendar, cotronella, eucalyptus, peppermint, camphor, sandalwood and cedar) have been used as antimicrobial in surface disinfectants, and thyme oil has been shown to be effective also against the gram negative bacterium P. aeruginosa at pH 8.9 when exposed for 5 minutes (EP 5,403,587).

As regards activity of perfume ingredients against particular microorganisms, the prior art reports conflicting results or one and the same perfume ingredient against one and the same microorganism, compare for example discussion of prior art in EP 0 451 889 A1. Therefore, it appears to be impossible to predict whether a known antimicrobial perfume ingredient will be suitable in a given formulation against a desired range of bacteria. In particular, it is not known and cannot be predicted whether any of the known antimicrobial perfume ingredients would provide a sufficiently strong antibacterial effect against gram-negative bacteria in a consumer product formulation, particularly a wash formulation for application to the skin. Furthermore, it cannot be predicted whether the effect, if any, would be sufficiently fast-acting (within 30 seconds).

It has now been found that various unsaturated aliphatic terpene alcohols or derivatives that had been reported to have antibacterial effects do not provide a sufficient antibacterial effect in formulations according to the present invention (e.g. geranyl acetate, linalyl acetate, citronellyl actetate, neryl acetate, geranyl formate, citronellyl formate, linalyl formate, neryl formate, geranyl propionate, citronellyl propionate, linalyl propionate, and neryl propionate).

There remains a need for bactericidal formulations with a reduced level of phenolic antibacterial compounds that have a good compatibility to human skin, and that are sufficiently effective, i.e. that act rapidly (within 30 seconds) and have a sufficiently high bactericidal activity against gram-negative bacteria, and preferably also against gram-positive bacteria, under conditions of use in moderately diluted form (for example, dilutions in water of 1:1 to 1:3).

A sufficiently high rapid bactericidal activity is considered to be reached when there is at least a 20-fold reduction in bacterial viability at 0.2% (w/v) of the bactericidal perfume ingredient, preferably at least a 20-fold reduction in bacterial viability at 0.1% (w/v) of the bactericidal perfume ingredient, and more preferably at least a 100-fold reduction in bacterial viability at a concentration of 0.1% (w/v) of the bactericidal perfume ingredient against at least one gram-negative bacterium, preferably at least one of Salmonella sp., Escherichia coli, Pseudomonas aeruginosa, Pseudomonas fluorescens, Klebsiella pneumoniae, and Serratia marcescens, when tested according to the test procedure as described in example 1 hereinunder.

All concentrations are indicated as w/v in this text unless otherwise indicated.

Relevant compounds need to produce a sufficiently high effectivity against gram-negative bacteria when used in formulations according to the invention in an end concentration of about 0.3% to 2%, in order to be effective upon use in moderately diluted form.

Surprisingly, it has been found that certain perfume ingredients have a bactericidal activity against gram-negative bacteria that is sufficiently effective (sufficiently active and rapid) and are compatible with formulations according to the invention.

### SUMMARY OF THE INVENTION

In one aspect, the invention is directed to a formulation comprising
(a) at least 0.2% (w/v) of one or more perfume ingredients having a sufficiently rapid bactericidal activity against gram-negative bacteria
(b) 4% to 20% (w/v) of a hydrotrope
(c) 0.1% to 9% (w/v) of one or more surfactant selected from the group consisting of anionic, non-ionic and amphoteric surfactants, or combinations thereof,
wherein the perfume ingredient is selected from the group consisting of Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Peppermint oil, Rose oil, Cinnamon leaf oil, Fucus oil, Clove bud oil, Clove leaf oil, Palmarosa oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyidihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof.

In another embodiment, the invention is directed to a formulation as described herein-above comprising in addition one or more of the following ingredients
(d) one or more agents active against gram-positive bacteria
(e) one or more chelating agents selected from the group consisting of EDTA, and CDTA, and a combination of (d) and (e).

In another embodiment, the invention is directed to a formulation as described herein-above wherein (b) is selected from toluene-sulfonate, xylene-sulfonate, cumene-sulfonate, diisobutyl-sulfosuccinate; or the sodium, ammonium or potassium salts of a hydrotrope selected from the group consisting of toluene-sulfonate, xylene-sulfonate, cumene-sulfonate, diisobutyl-sulfosuccinate; and Dipropyleneglycol-n-butyl-ether; or a combination of one or more of these hydrotropes.

In another embodiment, the invention is directed to a formulation as described herein-above wherein wherein (d) is selected from a chlorinated phenolic compound and Triclosan.

In another embodiment, the invention is directed to a formulation as described herein-above wherein the surfactant (c) is present in a concentration of 0.1% to 5% (w/v).

In another embodiment, the invention is directed to a formulation as described herein-above wherein the pH is about 4 to about 5.

In another embodiment, the invention is directed to a formulation as described herein-above wherein comprising a concentration of one or more of a phenolic biocide, a chlorinated phenolic biocide, or a combination thereof, selected from up to 0.5%, up to 0.4%, up to 0.2%, and 0%.

In another aspect, the invention is directed to a formulation comprising
(a) at least 0.2% (w/v) of one or more perfume ingredients having a sufficiently rapid bactericidal activity against gram-negative bacteria
(b) 4% to 20% (w/v) of a hydrotrope
(c) 0.1% to 9% (w/v) of one or more surfactant selected from the group consisting of anionic, non-ionic and amphoteric surfactants, or combinations thereof,
wherein the pH is about 4 to about 5.

In still another aspect, the invention is directed to a formulation comprising
(a) at least 0.2% of one or more perfume ingredients having a sufficiently rapid bactericidal activity against gram-negative bacteria
(b) 4% to 20% of a hydrotrope
(c) 0.1% to 9% of one or more surfactant selected from the group consisting of anionic, non-ionic and amphoteric surfactants, or combinations thereof,
further comprising one or more of a phenolic biocide, a chlorinated phenolic biocide, or a combination thereof, in a concentration of up to 0.5%, up to 0.4%, up to 0.2%.

In yet another aspect, the invention is directed to a formulation as described herein-above wherein selected from consumer products, personal care products, wash formulations for the human or animal body, in particular the skin, scalp or hair, hand wash formulations, aqueous soap formulations, syndet solutions (synthetic detergents), shower gels, shampoos, pet shampoos, disinfectant, formulations for disinfection and/or cleaning of inert surfaces, formulations for oral application, oral care products, mouth wash, tooth paste.

In another aspect, the invention is directed to a bactericidal perfume composition containing at least 70% (w/v) of at least 10 different bactericidal perfume ingredients, preferably and up to 30% of other non-bactericidal perfume ingredients.

In another embodiment, the invention is directed to bactericidal perfume composition as described herein-above wherein the bactericidal perfume ingredients are selected from Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Cinnamon leaf oil, Fucus oil, Palmarosa oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof.

In another aspect, the invention is directed to a method of providing rapid bactericidal consumer product formulations wherein one or more perfume ingredients as defined herein-above is admixed to ingredients (b) and (c) as defined herein-above.

In another embodiment, the invention is directed to a method as defined herein-above wherein one or more perfume ingredients as defined herein-above is admixed in addition to ingredients (d) and (e) as defined herein-above.

In another embodiment, the invention is directed to a method as defined herein-above wherein ingredient (e) is a selected from a phenolic compound, o-Phenyl-phenol, a chlorinated phenolic compound, 2-benzyl-4-chlorphenol, Triclosan, or combinations thereof.

In another embodiment, the invention is directed to a method as defined herein-above wherein ingredient (e) is present in a concentration of 0.02 to 0.5% (w/v).

### DETAILED DESCRIPTION OF THE INVENTION

Bactericidal formulations according to the invention are obtained by admixing the following ingredients in the specified amounts.

These formulations comprise
(a) at least 0.2% of one or more perfume ingredients having a sufficiently rapid bactericidal activity against gram-negative bacteria
(b) 4% to 20% of a hydrotrope
(c) 0.1% to 9% of one or more surfactant selected from the group consisting of anionic, non-ionic and amphoteric surfactants, or combinations thereof;
and preferably one or more of the following optional components selected from
(d) one or more agents active against gram-positive bacteria, preferably selected from phenolic compounds and chlorinated phenolic compounds,
(e) one or more chelating agents selected from the group consisting of EDTA, and CDTA,
and combinations of d and e.

A sufficiently rapid bactericidal activity of a perfume ingredient against gram-negative bacteria according to the invention is determined as follows. The perfume ingredient must have a reduction factor of bacterial viability of at least 20-fold when it is tested in a concentration of 0.2% in Mueller Hinton Broth with a contact time of 30 seconds as described below. The perfume ingredient is dissolved in dimethylsulfoxide (DMSO) in a concentration of 4% (w/v). An aliquot (10 μl) of the solution is added to individual wells of microtiter plates.

200 μl of Mueller-Hinton broth containing a bacterial inoculum of 2.5×10⁶ cfu (colony forming units) is added. After 30 s contact time, 20 μl of the test solution is removed and added to 180 μl of a neutralising solution (containing 3 g lecithin, 30 g Tween® 80, 5 g sodium thiosulfate, 1 g histidine, 30 g saponin, 8.5 g sodium chloride, 1 g tryptone and 1000 ml water). After 1 min incubation, the sample is serially diluted 1:1 in Micotiter-plates containing 100 μl Mueller-Hinton Broth per well, and then incubated for 24 h at 37° C. The maximal dilution showing bacterial growth is recorded to determine the number of surviving bacteria (so-called most probable number method, which is a well-known microbiological method), and results are compared to control samples without added perfumery chemicals. Reduction in bacterial viability is thus calculated by dividing numbers of bacteria in control samples by the number surviving in the treated samples. Perfume ingredients resulting in a >20 fold reduction in bacterial viability at 0.2% (w/v) are considered to have a sufficiently rapid bactericidal activity against gram-negative bacteria.

The perfume ingredient with rapid bactericidal activity against gram-negative bacteria may be selected from the group consisting of geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Peppermint oil, Rose oil, Cinnamon leaf oil, Fucus oil, Clove bud oil, Clove leaf oil, Palmarosa oil, White thyme oil, Red thyme oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool.

In a preferred embodiment, the bactericidal perfume ingredient active against gram-negative bacteria may be selected from the group consisting of geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, and 5-hexyl-furan-2(3H)-one, Geranium oil, Peppermint oil, Rose oil, Cinnamon leaf oil, Fucus oil, Clove bud oil, Clove leaf oil, Palmamosa oil, White thyme oil, Red thyme oil, and Origanum oil for their high rapid bactericidal activity.

In a particularly preferred embodiment, the perfume ingredients are selected from the group consisting of geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-entanol, Carvacrol, 2-methoxy-4-propyl-phenol, Eugenol, and Thymol for their very high rapid bactericidal activity.

The inventive formulation may also contain at least 0.2% (w/v) of a perfume composition with rapid bactericidal activity against gram-negative bacteria, wherein the perfume composition when tested as described in example 1 with an exposure time of 30 seconds has a reduction in bacterial viability of at least 20 at a test concentration of 0.2%, preferably at least 20 at a test concentration of 0.1%, and most preferably at least 100 at a test concentration of 0.1%.

The large variety of perfume ingredients of the present invention allows the perfumer to compose perfume compositions that are rapidly bactericidal as well as pleasing to the senses, which has not been possible before. Bactericidal perfume compositions that contain at least 70% (w/v) of at least 10, at least 20, or at least 30 of bactericidal perfume ingredients, preferably of the preferred groups of bactericidal perfume ingredients described above, form another aspect of the invention. Inventive perfume compositions may additionally contain non-bactericidal perfumes ingredients up to 30% for aesthetic reasons.

The perfume ingredients identified by the applicant may be mixed in different proportions according to their degree of rapid bactericidal activity and according to their olfactive notes. It is apparent to the perfumer how to select perfume ingredients to provide a pleasant overall perfume impression.

The surfactant may be selected from anionic, non-ionic and amphoteric surfactants, or a combination thereof, in particular a mixture of amphoteric and anionic surfactants. Surfactants are well known in the art and are described, for example, by Martin M. Rieger 1997, “Surfactant chemistry and classification”, In: Surfactants in cosmetics, second edition, surfactant science series volume 68, edited by Martin M. Rieger, Linda D. Rhein, pp. 1-28, Marcel Dekker, Inc., New York.

Perfume compositions and formulations according to the invention may contain additives and excipients including perfume ingredients well known in the art. Additional perfume ingredients may be added to provide or change a particular desired perfume note not achievable with the palette of bactericidal perfume ingredients of the invention. Such additives or excipients are, for example, described in “Perfume and Flavor Materials of Natural Origin”, S. Arctander, Ed., Elizabeth, N.J., 1960; in “Perfume and Flavor Chemicals”, S. Arctander, Ed., Vol. I & II, Allured Publishing Corporation, Carol Stream, USA, 1994; and “CTFA Cosmetic Ingredient Handbook”, J. M. Nikitakis (ed.), 1st ed., The Cosmetic, Toiletry and Fragrance Association, Inc., Washington, 1988.

However, rapid bactericidal formulations of the present invention do not contain any further surfactants or hydrotropes in addition to the ones present as indicated in a formulation according to the invention.

In formulations according to the invention, the antibacterial perfume ingredient or composition preferably is present at a concentration of 0.2 to 2% or higher, more preferably 0.4 to 1% of the total composition.

It has surprisingly been found that the inventive bactericidal compounds are particularly effective in antibacterial wash formulations according to the invention with a surfactant content from 0.1% to below 10%, preferably 0.1 to 9%, more preferably 0.1 to 8%, most preferably 0.1 to 5%. Most preferably, in addition, the total level of non-ionic and amphoteric surfactant is 0.1% to 5%, preferably 0.5% to 2%.

Compositions according to the present invention contain a hydrotrope. A hydrotrope is a compound that has the ability to act as co-solubiliser to solubilise perfume ingredients in compositions with low surfactant content while lacking surfactant properties itself, i.e. it does not form micelles.

Whether a test compound with solubilising activity is a hydrotrope may be easily tested by determining whether it shows a critical micelle concentration when the (I³⁷³)/(I³⁸⁴) ratio is tested using the pyrene 1:3 ratio (J. Aguiar, et al., Journal of colloid and interface science, 2003, 258:116-122) as follows:

The test compound (potential hydrotrope) is dissolved in water at 1.25% (w/v) and serial dilutions in water are prepared. To 100 μl of each dilution, 5 μl of a pyrene solution (0.4 mM in ethanol) is added. After equilibration, the fluorescence of the solution with an excitation at 335 nm is determined. The ratio between the fluorescence signal at an emission wavelength of 373 nm (I³⁷³) and the signal measured at a 384 nm emission (I³⁸⁴) is then calculated. In solutions of compounds which form micelles, the ratio (I³⁷³)/(I³⁸⁴) decreases at the so called critical micelle concentration to reach a low plateau when the concentration is further increased. The exact extent of the decrease varies with the substance. It can be, for example, at least 10, 20, or 30% based on the value for water. A common decrease is about 33% (compare example 10).

In solutions of hydrotropes, the ratio (I³⁷³)/(I³⁸⁴) (i.e the pyrene 1:3 ratio) either remains about constant or shows at least an initial increase with increasing concentration, but no significant decrease, for example below 10% below the initial value. In contrast, surfactants show a marked decrease of, for example, at least 10, 20 or 30%, to reach a plateau at a lower value.

Suitable hydrotropes have the ability to solubilise antibacterial perfume ingredients according to the present invention in compositions with low surfactant levels, where antibacterial perfume ingredients are not sufficiently solubilised. When the antibacterial perfume ingredients are added at a concentration of 0.5-1% to a formulation lacking a hydrotrope but otherwise according to the invention, the formulations will form a turbid solution which becomes clear upon admixture of useful hydrotrope in a concentration of 4-12% as determined by visual inspection.

In particular, hydrotropes suitable for formulations according to the invention include short-chain alkyl aryl sulfonates but exclude compounds sometimes referred to as hydrotropes such as succinate and other bi-carboxylic acids which do not function in formulations according to the invention.

Examples of suitable hydrotropes include toluene sulfonate, xylene sulfonate, and cumene sulfonate, toluene sulfonic acid, xylene sulfonic acid, polystyrene sulfonate, dipropyleneglycol-n-butyl-ether, diisobutyl sulfosuccinate, di-isopropyl sulfosuccinate, di-n-propyl sulfosuccinate, diethyl sulfosuccinate, and their sodium, ammonium or potassium salts, or a combination thereof.

Preferred hydrotropes include benzene sulfonate, toluene sulfonate, xylene sulfonate, and cumene sulfonate, toluene sulfonic acid, xylene sulfonic acid, polystyrene sulfonate, and their sodium, ammonium or potassium salts, or a combination thereof.

The hydrotrope is present at a concentration of 4% to 20%, preferably 5-12%, and preferably is selected from the group consisting of toluene sulfonate, xylene sulfonate, cumene sulfonate, diisobutyl sulfosuccinate; or the sodium, ammonium or potassium salts of a hydrotrope selected from the group consisting of toluene sulfonate, xylene sulfonate, cumene sulfonate, diisobutyl sulfosuccinate; and dipropyleneglycol-n-butyl-ether (CAS 29911-28-2, for example Dowanol™ DPNB, commercially available from Dow Chemicals, Midland, Mich., USA); or a combination of one or more of these hydrotropes. Especially preferred hydrotropes are diisobutyl sulfosuccinate or its sodium ammonium or potassium salt, and Dipropyleneglycol-n-butyl-ether, or a combination thereof.

Whereas E coli, Salmonella sp., Klebsiella sp., Serratia sp. and Staphylococci are among the most prominent pathogens, it is well known that gram-negative bacteria of the genus of Pseudomonas, especially Pseudomonas aeruginosa, are particularly resistant organisms to kill. It is desirable to have effective formulations that are able to kill these organisms. Surprisingly, it has been found that, by addition of certain chelating agents, formulations with a rapid high bactericidal activity can be provided that have also a rapid high activity against bacteria of the genus of Pseudomonas, and in particular Pseudomonas aeruginosa. Notably, this higher broad-band activity is specific to the selected chelating agents, since a large proportion of tested chelating agents are not able to provide this improved activity, for example NTA (nitrilotriacetic acid), EDDS (ethylendiaminedisuccinic acid), Aminotri (methylene-phosponic acid) (Dequest® 2000, Solutia Inc., St. Louis, Mo., USA), 1-hydroxyethylidene-1,1-phosphonic acid (Dequest® 2010, Solutia Inc., St. Louis, Mo., USA), Diethylenetriaminepentakis (methyl phosphonic acid), IDS (iminodisuccinic acid) and DTPA (di-ethylen-triamine-penta-acetate, CAS 67-43-6).

Therefore, in a preferred embodiment, formulations according to the invention that in addition include a chelating agent selected from ethylenediaminetetraacetic acid, CAS 60-00-4 (EDTA) or (trans 1,2-diaminocyclohexane-N,N,N′N′-tetraacetic acid) (CDTA) are provided. For a particularly effective formulation, EDTA or CDTA is present in a concentration of 0.01 to 1%, preferably 0.05 to 0.5%, most preferably 0.075 to 0.25%.

In another preferred embodiment, antibacterial formulations provide broadband activity and are active against gram-negative and gram-positive bacteria. Gram-positive organisms which are transferred by hand and skin contact include Staphylococcus aureus, Staphylococcus epidermidi, Staphylococcus haemolyticus, and various specied belonging to the group of Corynebacteria. For action against gram-positive bacteria, an active ingredient that is active against gram-positive bacteria may be added. Suitable active ingredients include phenolic compounds that are not chlorinated, for example o-phenyl-phenol, and chlorinated phenolic compounds. Chlorinated phenolic compounds are preferably employed in a low concentration of 0.02 to 0.5%, for example up to 0.4%, preferably up to 0.2%. Suitable chlorinated phenolic compounds are selected from Triclosan, 2-benzyl-4-chlorphenol, and mixtures thereof. Chlorinated phenolic compounds may be mixed with non-chlorinated phenolic compounds.

Alternatively or additionally, to provide the preferred broadband bactericidal activity formulation even without addition of other ingredients active against gram-positive bacteria such as Triclosan, the pH may be adjusted to about pH 4 to 5. In addition to the pH adjustment, a chelating agent selected from EDTA and CDTA may be added. The pH of 4 to 5 and the chelating agent selected from EDTA and CDTA may also be combined to provide the broadband bactericidal activity. Preferably, these formulations contain a low concentration of phenolic biocides, for example up to up to 0.4%, preferably up to 0.2%, more preferably 0% of a chlorinated phenolic biocide, in particular triclosan.

Some antibacterial perfume ingredients including in particular geraniol, citronellol and linalool are suspected of being allergenic and there is a desire to leave out or reduce the quantity of these ingredients.

In a preferred embodiment, the invention provides an antibacterial formulation or a perfume composition for such a formulation without these perfume ingredients.

Bactericidal formulations of the present invention include personal care products and consumer products, wash formulations for the human or animal body, in particular the skin, scalp or hair, including hand wash formulations, aqueous soap formulations, syndet solutions (synthetic detergents), shower gels, shampoos, pet shampoos, disinfectant, formulations for disinfection and/or cleaning of inert surfaces.

To provide formulations suitable for oral application such as oral care products including mouth wash and tooth paste, food-grade hydrotropes suitable for oral application at the concentration of use should be used.

The invention is further described with reference to the following non-limiting examples, which describe preferred embodiments.

### EXAMPLE 1

### Materials with Rapid Bactericidal Effect on Gram-Negative Bacteria

Test organisms Escherichia coli (ATCC 10536), Salmonella typhimurium (ATCC 13311) and Pseudomonas aeruginosa (ATCC 15442) are used. For Pseudomonas aeruginosa the test solution contains additionally 0.1% EDTA.

A large number of commercially-available materials including a collection of 900 perfumery chemicals is tested. The materials are dissolved in dimethylsulfoxide (DMSO) in a concentration of 4% (w/v). An aliquot (5 μl or 10 μl) of each solution is added to individual wells of microtiter plates. 200 μl of Mueller-Hinton broth containing a bacterial inoculum of 2.5×10⁶ cfu (colony forming units) is added. After 30 s and 60 s contact time, 20 μl of the test solution is removed and added to 180 μl of a neutralising solution (containing 3 g lecithin, 30 g Tween® 80, 5 g sodium thiosulfate, 1 g histidine, 30 g saponin, 8.5 g sodium chloride, 1 g tryptone and 1000 ml water). After 1 min incubation, the samples are serially diluted 1:1 in Micotiter-plates containing 100 μl Mueller-Hinton Broth per well, and then incubated for 24 h at 37° C. The maximal dilution showing bacterial growth is recorded to determine the number of surviving bacteria (so-called most probable number method, which is a well-known microbiological method), and results are compared to control samples without added perfumery chemicals. Reduction in bacterial viability is thus calculated by dividing numbers of bacteria in control samples by the number surviving in the treated samples.

Tested materials are classified into groups according to their rapid bactericidal activity (very high, high, sufficient or none), with very high activity indicating an at least 100 fold reduction in bacterial viability at a concentration of 0.1% (w/v) perfume ingredient, high activity indicating an at least 20 fold reduction in bacterial viability at 0.1% (w/v) and sufficient activity indicating an at least 20 fold reduction in bacterial viability at 0.2% (w/v).

The following materials (all fragrant perfume ingredients) are found to have a surprisingly rapid bactericidal effect against gram-negative bacteria.

Perfume ingredients with a rapid (30 s) bactericidal effect on gram-negative bacteria:
Perfume ingredients with very high bactericidal activity: Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, and Thymol.
Perfume ingredients with high bactericidal activity:
4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, and 5-hexyl-furan-2(3H)-one.
Perfume ingredients with high activity, natural oils:
Geranium oil, Peppermint oil, Rose oil, Cinnamon leaf oil, Fucus oil, Clove bud oil, Clove leaf oil, Palmarosa oil, White thyme oil, Red thyme oil, Origanum oil.
Perfume ingredients with sufficient activity:
3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, Tetrahydrolinalool.

Several hundred of materials tested do not have the desired rapid bactericidal effect. Some examples of perfume ingredients without activity: Geranyl-acetate, linalyl-acetate, citronellyl-actetate, neryl-acetate, Geranyl-formiate, citronellyl-formiate, linalyl-formiate, neryl-formiate, Geranyl-propionate, citronellyl-propionate, linalyl-propionate, and neryl-propionate.

### EXAMPLE 2

### Perfume Composition With Rapid Bactericidal Effect Against Gram-Negative Bacteria

By using perfume ingredients of different activity as defined in example 1, the perfumer can mix a perfume that has a rapid bactericidal effect against gram-negative bacteria, that is sufficiently active and pleasing to the nose at the same time. Such a perfume is created by mixing 42% perfume ingredients with high activity, 30% with intermediate activity and 19% with low activity as shown below.

Inventive perfume composition A

| Perfume ingredient: | Parts per 1000 |
|---|---|
| Geraniol | 100 |
| 3-methyl-5-phenyl-pentanol | 100 |
| dec-9-en-1-ol | 10 |
| 2,2-dimethyl-3-(3-methyl phenyl)-propanol | 50 |
| 4-(1-methylethyl)cyclohexyl-methanol | 50 |
| Nerol | 30 |
| 3,7-dimethyl-7-octen-1-ol | 20 |
| 2-methyl-5-phenyl-pentanol | 60 |
| Thymol | 3 |
| 2-(1-methylpropyl)-cyclohexanone | 30 |
| Dihydromyrcenol | 200 |
| 4-(1,1-dimethylethyl)-cyclohexanol | 20 |
| 5-hexyl-furan-2(3H)-one | 2 |
| 3,5-dimethyl-cyclohex-3-en-1-carboxaldehyde | 15 |
| Dihydroterpineol | 150 |
| 1-(2-naphthalenyl)-ethanone | 30 |
| palmarosa oil | 50 |
| clove oil | 40 |
| Geranium oil | 40 |

The antibacterial effect of the inventive perfume composition is compared to two commercially available perfume compositions as described in example 1. The reduction factor in bacterial numbers tested on E. coli for these perfume compositions are listed in the table below.

TABLE 1

| | | | | Perfume |
|---|---|---|---|---|
| | | | Perfume | composition |
| | Contact | Perfume | composition B | C |
| Concentration | time | composition | (commercial | (commercial |
| [% w/v] | [seconds] | A | product) | product) |
| 0.075 | 30 | 4 | 1 | 1 |
| 0.1 | 30 | 215 | 1 | 4 |
| 0.2 | 30 | >20000 | 1 | 2 |
| 0.3 | 30 | >20000 | 1 | 4 |
| 0.4 | 30 | >20000 | 1 | 2 |
| 0.075 | 60 | 32 | 1 | 1 |
| 0.1 | 60 | >20000 | 2 | 1 |
| 0.2 | 60 | >20000 | 1 | 1 |
| 0.3 | 60 | >20000 | 2 | 4 |
| 0.4 | 60 | >20000 | 2 | 4 |

### EXAMPLE 3

### Formulations Providing a Rapid Bactericidal Activity

The following liquid wash formulations (see table below) are tested.

TABLE 2
Liquid wash formulations for the human skin

| | | I | II | III | IV | V | VI | VII |
|---|---|---|---|---|---|---|---|---|
| Cocamidopropyl | Amphoteric | 3.75 | 3 | 2.25 | 0.75 | 0.75 | 0.75 | 0.75 |
| betaine | surfactant | | | | | | | |
| Ammonium lauryl | Anionic | 12 | 9.6 | 7.2 | 2.4 | 2.4 | 2.4 | 2.4 |
| sulfate | surfactant | | | | | | | |
| Sodium xylene | Hydrotrope | 12 | 12 | 12 | 12 | 6 | 3 | 0 |
| sulfonate | | | | | | | | |
| Dipropyleneglycol | Solvent | 5 | 5 | 5 | 5 | 5 | 5 | 5 |
| pH (adjusted with | | 5.6 | 5.6 | 5.6 | 5.6 | 5.6 | 5.6 | 5.6 |
| citric acid and | | | | | | | | |
| phosphate) | | | | | | | | |

The above formulations are supplemented with 0.9% (w/v) of the perfume composition A of example 2. A control of each formulation is left un-perfumed. The rapid bactericidal activity of these formulations is then tested as follows:
The products are diluted 1:1 in hard water as defined in the European standard EN 1276. This mimics conditions of use on wet hands or wet surfaces in commonly used water.
500 μl of the product is mixed with 25 μl of a bacterial inoculum containing 2×10⁸ cfu/ml (colony forming units).
The mixture is incubated for 30 seconds at 37° C.
20 μl of the mixture is removed and added to 180 μl neutralising solution (containing 3 g lecithin, 30 g Tween® 80, 5 g sodium thiosulfate, 1 g histidine, 30 g saponin, 8.5 g sodium chloride, 1 g tryptone and 1000 ml water).
The mixture with neutraliser is incubated for 1 min
Serial dilutions of the mixture with neutralising solution are made, and aliquots of these are added to Petri-dishes and embedded in tryptic soy agar containing 0.5% Tween® 80 to inactivate any residual antibacterial compounds.
Bacterial numbers are counted after 24 h incubation at 37° C. and compared to control samples.
Reduction in bacterial viability is determined as described in example 1

Formulations are tested in a dilution of 1:1 and with 30 seconds contact time to bacteria (E. coli). The results are listed in the table below with the numbers indicating the reduction in bacterial viability and a reduction factor of 10 indicating that 90%, of 20 indicating that 95%, of 100 indicating that 99%, and of 200 indicating that 99.5% of the bacteria are killed.

TABLE 3
Rapid bactericidal activity of different formulations comprising
inventive perfume composition A of example 2.

| | I | II | III | IV | V | VI | VII |
|---|---|---|---|---|---|---|---|
| No perfume added | 1.4 | 1.5 | 0.9 | 1.4 | 1.4 | (tur.) | (tur.) |
| 0.9% perfume composition | 1.5 | 1.1 | 1.6 | >250 | 154 | (tur.) | (tur.) |
| A of example 2 | | | | | | | |

(tur.) = Turbid, these formulations are unstable with the perfume ingredient not sufficiently solubilised

As can be seen in the table, formulation IV and V with a low level of surfactants and a high level (6-12%) of hydrotrope provides a high rapid bactericidal activity, whereas in other formulations the activity of the perfume composition is either lost, or the formulation is unstable and the perfume is not completely solubilised, which is undesirable in a consumer product. Inventive formulations provide a rapid bactericidal activity while maintaining good solubility.

### EXAMPLE 4a

### Formulations Providing Broad Band Bactericidal Activity

Formulation IV of example 3 is supplemented with different concentrations of phenolic biocides and different concentrations of the perfume composition A of example 2. The reduction in viability of various test organisms is determined at different dilutions of the formulation (1:1 or 1:3 to simulate conditions of use) after 30 seconds contact time. Inventive formulations have a rapid, high and broad-band bactericidal effect in different dilutions as, as shown in the table below.

TABLE 4

| | | Perfume | | | | | | |
|---|---|---|---|---|---|---|---|---|
| | | composition A | | | | | | |
| | Triclosan | of example 2 | E. coli, | E. coli, | Salmonella, | Salmonella, | S. aureus, | S. aureus, |
| | [% (w/v)] | [% (w/v)] | 1:1 | 1:3 | 1:1 | 1:3 | 1:1 | 1:3 |
| IV | 0 | 0 | 2 | 1 | 3 | 1 | 2 | 1 |
| IVa | 0 | 0.9 | >250 | >250 | >250 | >250 | 4 | 1 |
| IVb | 0.8 | 0 | 227 | 88 | >250 | >250 | 166 | 250 |
| IVc | 0.4 | 0 | 9 | 75 | 216 | >250 | 166 | 50 |
| IVd | 0.4 | 0.45 | >250 | 204 | >250 | >250 | 229 | 13 |
| IVe | 0.4 | 0.9 | >250 | >250 | >250 | >250 | 229 | 10 |
| IVf | 0.2 | 0 | 6 | 37 | 10 | 2 | 26 | 2 |
| IVg | 0.2 | 0.45 | >250 | 223 | >250 | >250 | 60 | 3 |
| IVh | 0.2 | 0.9 | >250 | >250 | >250 | >250 | 166 | 2 |
| IVi | 0 | 0.45 | 103 | 5 | >250 | 2 | 5 | n.d.* |

*n.d. = not determined

Formulations containing a high concentration of triclosan (0.8%) have a rapid high activity against most bacterial organisms.

If the concentration of triclosan is lowered to 0.2% (formula IVf) activity for gram-negative organisms is lost. The inventive formulation IV comprising an inventive perfume composition (IVd and IVe) has the advantage of having a reduced concentration of the chlorinated phenolic biocide, which is desired by consumers, while maintaining a rapid high broad band activity against both gram-negative and gram-positive (S. aureus) bacteria. The results demonstrate that a high concentration of triclosan (0.8%) can be reduced while maintaining a rapid bactericidal effect for gram-negative organisms in formulations according to the invention that comprise inventive perfume compositions.

### EXAMPLE 4b

### Formulations Providing Broad Band Bactericidal Activity

Formulations IVf, IVg, and IVh with a reduced level of a phenolic biocide (0.2% w/v)of example 4 are tested for their rapid bactericidal activity on gram-negative test organisms Klebsiella pneumoniae and Serratia marcescens. Tests are conducted as described in example 4.

The table below shows the results for the reduction in viability of gram-negative test organisms at a 1:1 dilution of the formulations (IVf, IVg, IVh) after a contact time of 30 seconds.

TABLE 5

| | | Perfume | | |
|---|---|---|---|---|
| | | composition | | |
| | Triclosan | of example 2 | K. pneumoniae, | S. marcescens, |
| | [% w/v] | [% w/v] | 1:1 | 1:1 |
| IVf | 0 | 0 | 1 | 1 |
| IVg | 0.2 | 0 | 2 | 1 |
| IVh | 0.2 | 0.45 | >450 | >500 |

These results demonstrate that inventive formulations provide a rapid high bactericidal effect against Klebsiella pneumoniae and Serratia marcescens of a similar quality as against E. coli, Salmonella and S. aureus (data for the latter shown in example 4a). Thus, even at a low level of phenolic biocide, a rapid high broad band activity can be achieved with inventive formulations.

### EXAMPLE 5a

### Rapid, High, Broad-Band Activity Bactericidal Formulation Active Against Pseudomonas

Formulations active against the bacterial strains of example 4a and 4b and additionally against Pseudomonas bacteria comprise an antibacterial perfume composition, a phenolic biocide (triclosan) and EDTA.

The formulations IV and IV b-h are supplemented with EDTA in various concentrations as indicated in the table below. The resulting formulations are tested in a 1:1 dilution for their rapid bactericidal effects after 30 seconds for Pseudomonas aeruginosa. The results are shown in the table below.

In the absence of EDTA no rapid bactericidal activity is observed in any of the formulations tested. Formulations containing of 0.2 to 0.8% w/v of a phenolic biocide (triclosan) but no perfume composition according to the invention (IVa, IVb, IVe) show no or only a very low bactericidal effect against Pseudomonas aeruginosa.

Formulations containing low concentrations of a phenolic biocide (triclosan 0.2%, 0.4%) and the inventive perfume composition (IVc, IVd, IVf, IVg) and EDTA show a high rapid bactericidal activity for Pseudomonas aeruginosa.

TABLE 6

| | | Perfume composi- | | | |
|---|---|---|---|---|---|
| Formu- | Triclosan | tion of example 2 | EDTA | EDTA | EDTA |
| lation | [% w/v] | [% w/v] | 0% | 0.1% | 0.2% |
| IVb | 0.8 | 0 | 1 | — | — |
| IVc | 0.4 | 0 | 1 | 2 | 42 |
| IVd | 0.4 | 0.45 | 2 | 42 | 166 |
| IVe | 0.4 | 0.9 | 10 | 166 | 166 |
| IVf | 0.2 | 0 | 1 | 2 | 2 |
| IVg | 0.2 | 0.45 | 3 | 166 | 166 |
| IVh | 0.2 | 0.9 | 6 | 166 | 166 |

### EXAMPLE 5b

### Rapid, High, Broad-Band Activity Bactericidal Formulation Active Against Pseudomonas

Formulation IVg is supplemented as indicated in the table below with various different chelating agents instead of EDTA and is tested as described in example 5a. The resulting products are tested with 30 s contact time at a 1:1 dilution for bactericidal effects on P. aeruginosa.

No activity is present in absence of EDTA and CDTA. The addition of CDTA (trans 1,2-diaminocyclohexane-N,N,N′N′-tetraacetic acid) similarly to EDTA further improves the effectiveness.

No activity is present when using the following chelating agents instead of EDTA or CDTA:

NTA (nitrilotriacetic acid), EDDS (ethylendiaminedisuccinic acid),

Aminotri(methylene-phosponic acid) (Dequest® 2000, Solutia Inc., St. Louis, Mo., USA), 1-hydroxyethylidene-1,1-phosphonic acid (Dequest® 2010, Solutia Inc., St. Louis, Mo., USA), Diethylenetriaminepentakis (methyl phosphonic acid), IDS (iminodisuccinic acid) and DTPA (di-ethylen-triamine-penta-acetate).

TABLE 7

| | | | Perfume | Reduction in |
|---|---|---|---|---|
| | | | (%) | viability |
| Formu- | | Triclosan | according | P. |
| lation | Chelating agent | (%) | example 2 | aeruginosa |
| IVe | none | 0.2 | 0.45 | 1.5 |
| IVe | EDTA 0.1% | 0.2 | 0.45 | >200 |
| IVe | CDTA 0.1% | 0.2 | 0.45 | >200 |
| IVe | DTPA 0.1% | 0.2 | 0.45 | 2 |
| IVe | EDDS 0.1% | 0.2 | 0.45 | 1.5 |
| IVe | Dequest ® 2000 | 0.2 | 0.45 | 2.4 |
| IVe | Dequest ® 2010 | 0.2 | 0.45 | 1.6 |
| IVe | iminodisuccinic acid | 0.2 | 0.45 | 1.45 |
| | (IDS) | | | |
| IVe | Diethylene- | 0.2 | 0.45 | 1 |
| | triaminepentakis(methyl | | | |
| | phosphonic acid | | | |
| IVe | nitrilotriacetic acid | 0.2 | 0.45 | 1.5 |

### EXAMPLE 6

### Effect of Solvents Such as Dipropyleneglycol in Formulations According to the Invention

For cosmetic performance to improve skin mildness, solvents such as dipropyleneglycol may be added to the inventive formulation. Some solvents have been reported to have a bactericidal effect in certain formulations. The bactericidal effect of dipropyleneglycol in formulations IVb, IVf, IVg, IVh, IVi of example 4 without solvent and supplemented with 5% solvent (w/v) is tested using E. coli after a 30 second contact time.

For inventive formulations with and without solvent, no differences in rapid bactericidal activity are observed. Therefore, the solvent is not an essential part of the bactericidal principle in the inventive formulations.

### EXAMPLE 7

### Formulations of the Invention May Employ Different Hydrotropes

The tested base formulation contains 0.75% (w/v) Cocamidopropyl betaine, 2.4% (w/v) Ammonium lauryl sulphate, and 5% Dipropyleneglycol, pH 5.6 (adjusted with citric acid and phosphate). The base formulation is supplemented with various hydrotropes (diisobutylsulfosuccinate, sodium xylene sulfonate, dipropyleneglycol-n-butyl-ether) in the concentrations as indicated in the table below. Activity of the concentrated formulation, and the formulation in dilution (1:1, 1:3) is tested after 30 s contact time employing E. coli.

The results are shown in the table below. All hydrotropes or hydrotrope combinations together with the bactericidal perfume composition A of example 2 provide a high rapid bactericidal activity of 250 or higher in a stable formulation even at a dilution of 1:3.

TABLE 8

| Supplements to | Triclosan | Perfume | E. coli, | E. coli, | E. coli, |
|---|---|---|---|---|---|
| formulation VII | [% w/v] | [% w/v] | conc. | 1:1 | 1:3 |
| 6% diisobutyl- | 0 | 0 | 0 | 1 | 1 |
| sulfosuccinate | 0.2 | 0 | 1 | 2 | 3 |
| | 0.2 | 0.45 | >250 | >250 | >250 |
| 3% diisobutyl- | 0 | 0 | 1 | 1 | 1 |
| sulfosuccinate, | | | | | |
| 3% sodium xylene | 0.2 | 0 | 4 | 1 | 2 |
| sulfonate | 0.2 | 0.45 | >250 | n.d. | 250 |
| 3% Dipropylene- | 0 | 0 | >250 | 2 | 1 |
| glycol-n-butyl-ether, | 0.2 | 0 | >250 | 50 | 50 |
| 3% sodium xylene | 0.2 | 0.45 | >250 | >250 | >250 |
| sulfonate | | | | | |

n.d.: not determined.

### EXAMPLE 8

### Formulations With Broad Band Bactericidal Activity Without Phenolic Biocides

The tested base formulation is the same as in example 7 and is supplemented as indicated in the table below, in particular with different hydrotropes, a low pH, EDTA and the perfume composition A of example 2. The rapid bactericidal effect is determined after 30 s contact time employing various bacteria as indicated in the table below at the indicated dilutions (1:1, 1:3).

TABLE 9

| | | | | E. coli | E. coli | S. aureus | P. aeruginosa |
|---|---|---|---|---|---|---|---|
| Supplements to formulation VII | Perfume | EDTA | pH | 1:1 | 1:3 | 1:1 | 1:1 |
| 12% sodium xylene sulfonate | 0 | 0 | 5.6 | 1 | 1 | 1 | 1 |
| 12% sodium xylene sulfonate | 0 | 0 | 4.5 | 125 | 1 | 11 | 2 |
| | 0.45 | 0 | 4.5 | >250 | 2 | 31 | >250 |
| | 0 | 0.1 | 4.5 | >250 | 1 | 17 | 250 |
| | 0.45 | 0.1 | 4.5 | >250 | 31 | >250 | >250 |
| 3% Dipropyleneglycol-n-butyl-ether, | 0 | 0 | 4.5 | >250 | 83 | 7 | 2 |
| 3% sodium xylene sulfonate | 0.45 | 0 | 4.5 | >250 | >250 | 25 | >250 |
| | 0.45 | 0.1 | 4.5 | >250 | >250 | 28 | >250 |

### EXAMPLE 9

### The Use of Different Phenolic Biocides

Formulations IV of example 3 that contain various phenolic biocides which are commonly employed in consumer care products are tested, as indicated in the table below. The rapid bactericidal effect is determined within 30 s contact time employing E. coli and S. aureus.

At a low concentration of 0.2%, an insufficient activity is observed for all phenolic biocides tested. Concentrations of 0.4% phenolic biocide shows higher activities at least for some biocides for the 1:1 dilution on E. coli, however not on S. aureus, so even with this higher concentration a broad band rapid bactericidal activity cannot be provided.

Formulations containing in addition to the 0.2 and 0.4% phenolic biocide the inventive perfume compositions of example 2 shows a broad band, high, rapid bactericidal effect.

TABLE 10

| | Biocide | Perfume | E. coli | E. coli | S. aureus |
|---|---|---|---|---|---|
| Biocide | % | % | 1:1 | 1:3 | conc. |
| No biocide | 0 | 0 | 1 | 1 | 1 |
| 2-benzyl-4- | 0.2 | 0 | 1 | 1 | 1 |
| chlorphenol | | | | | |
| 2-benzyl-4- | 0.2 | 0.45 | >250 | 2 | 1 |
| chlorphenol | | | | | |
| 2-benzyl-4- | 0.4 | 0 | 18 | 1 | 3 |
| chlorphenol | | | | | |
| 2-benzyl-4- | 0.4 | 0.45 | >250 | 4 | 21 |
| chlorphenol | | | | | |
| 2-benzyl-4- | 0.4 | 0 | >250 | 3 | 2 |
| chlorphenol/o- | | | | | |
| Phenyl-phenol | | | | | |
| 1:1 mixture | | | | | |
| 2-benzyl-4- | 0.4 | 0.45 | >250 | 250 | 28 |
| chlorphenol/o- | | | | | |
| Phenyl-phenol | | | | | |
| 1:1 mixture | | | | | |
| Triclosan | 0.2 | 0 | 1 | 1 | 12 |
| Triclosan | 0.2 | 0.45 | >250 | 2 | 31 |

### EXAMPLE 10

### Determination of a Hydrotrope According to the Invention Based on the Pyrene 1:3 Ratio and Solubilisation Behaviour

Test compounds are dissolved in water at 1.25% and serial dilutions in water are prepared. To 100 μl of each dilution, 5 μl of a pyrene solution (0.4 mM in ethanol) is added. After equilibration, the fluorescence of the solution with an excitation at 335 nm is determined on an LS-50 Perkin Elmer fluorescence spectrometer. The ratio between the fluorescence signal at an emission wavelength of 373 nm (I³⁷³) and the signal measured at a 384 nm emission (I³⁸⁴) is then calculated. Hydrotropes as defined in this invention show a constant or increasing ratio (I³⁷³)/(I³⁸⁴) instead of a marked decrease. In contrast, surfactants show a marked decrease of this parameter at a certain concentration.

TABLE 11

| | | | Alcohols, C9-11, | | | | Dipropylene- |
|---|---|---|---|---|---|---|---|
| | Sodium | Cocoamido- | ethoxylated | hydrogenated | Diisopropyl- | Sodium xylene | glycol-n-butyl- |
| CONC (%) | dodecylsulfate⁽¹⁾ | propylbetaine⁽¹⁾ | (Neodol ™⁽¹⁾ | castor oil⁽¹⁾ | sulfosuccinate⁽²⁾ | sulfonate⁽²⁾ | ether⁽²⁾ |
| 0.00 | 1.28 | 1.28 | 1.28 | 1.28 | 1.28 | 1.28 | 1.28 |
| 0.01 | 1.11 | 1.19 | 1.05 | 0.99 | 1.21 | 1.37 | 1.23 |
| 0.02 | 1.12 | 1.02 | 0.93 | 0.97 | 1.21 | 1.46 | 1.28 |
| 0.04 | 1.08 | 0.87 | 0.97 | 0.90 | 1.20 | 2.84 | 1.29 |
| 0.08 | 0.92 | 0.80 | 0.90 | 0.87 | 1.36 | 1.62 | 1.25 |
| 0.16 | 0.78 | 0.80 | 0.96 | 0.97 | 1.99 | 1.49 | 1.25 |
| 0.31 | 0.79 | 0.78 | 0.92 | 0.97 | 1.65 | 1.43 | 1.30 |
| 0.63 | 0.75 | 0.79 | 0.94 | 0.95 | 1.48 | 1.41 | 1.31 |
| 1.25 | 0.74 | 0.78 | 0.91 | 0.88 | 1.39 | 1.04 | 1.67 |

⁽¹⁾surfactants which form micelles
⁽²⁾hydrotropes according to the invention

Neodol™ is commercially available from Shell Chemicals, UK.

To determine the positive effect of the potential hydrotropes on the solubilisation of perfume ingredients, Formulation VII according example 3 is supplemented with 0.9% perfume composition a according example 2. To this turbid mixture the potential hydrotropes or hydrotrope mixtures are added at various concentrations from 4% to 20%. Compounds which act as co-solubilisers in these formulations with low surfactant levels, i.e. lead to a clear solution, but lacking the ability to form micelles as described above are useful hydrotropes according the invention.

1. A formulation comprising:
(a) at least 0.2% (w/v) of one or more perfume ingredients having a sufficiently rapid bactericidal activity against gram-negative bacteria
(b) 4% to 20% (w/v) of a hydrotrope
(c) 0.1% to 9% (w/v) of one or more surfactant selected from the group consisting of anionic, non-ionic and amphoteric surfactants, or combinations thereof,
wherein;
the perfume ingredient is selected from the group consisting of Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Peppermint oil, Rose oil, Cinnamon leaf oil, Fucus oil, Clove bud oil, Clove leaf oil, Palmarosa oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof.

2. A formulation according claim 1 additionally comprising one or more of
(d) one or more agents active against gram-positive bacteria
(e) one or more chelating agents selected from the group consisting of EDTA, and CDTA.

3. A formulation according to claim 1 wherein:
(b) the hydrotrope is selected from; toluene-sulfonate, xylene-sulfonate, cumene-sulfonate, diisobutyl-sulfosuccinate; or the sodium, ammonium or potassium salts of a hydrotrope selected from the group consisting of toluene-sulfonate, xylene-sulfonate, cumene-sulfonate, diisobutyl-sulfosuccinate; and Dipropyleneglycol-n-butyl-ether; or a combination of one or more of the foregoing.

4. A formulation according to claim 2 wherein
(d) the one or more agents active against gram-positive bacteria is selected from a chlorinated phenolic compound and Triclosan.

5. A formulation according to claim 1 wherein the surfactant (c) is present in a concentration of 0.1% to 5% (w/v).

6. A formulation according to claim 1, wherein the formulation has a pH of about 4 to about 5.

7. A formulation according to claim 1 comprising a concentration of one or more of; a phenolic biocide, a chlorinated phenolic biocide, or a combination thereof.

8. A formulation comprising
(a) at least 0.2% (w/v) of one or more perfume ingredients having a rapid bactericidal activity against gram-negative bacteria
(b) 4% to 20% (w/v) of a hydrotrope
(c) 0.1% to 9% (w/v) of one or more surfactant selected from the group consisting of anionic, non-ionic and amphoteric surfactants, or combinations thereof,
wherein the pH of the formulation is about 4 to about 5.

9. A formulation comprising
(a) at least 0.2% of one or more perfume ingredients having a rapid bactericidal activity against gram-negative bacteria
(b) 4% to 20% of a hydrotrope
(c) 0.1% to 9% of one or more surfactant selected from the group consisting of anionic, non-ionic and amphoteric surfactants, or combinations thereof, further comprising one or more of; a phenolic biocide, a chlorinated phenolic biocide, or a combination thereof.

10. A formulation according to claim 1, wherein the formulation is selected from:
consumer products, personal care products, wash formulations for the human or animal body, in particular the skin, scalp or hair, hand wash formulations, aqueous soap formulations, syndet solutions (synthetic detergents), shower gels, shampoos, pet shampoos, disinfectant, formulations for disinfection and/or cleaning of inert surfaces, formulations for oral application, oral care products, mouth wash, tooth paste.

11. A bactericidal perfume composition containing at least 70% (w/v) of at least 10 different bactericidal perfume ingredients, and optionally up to 30% of other non-bactericidal perfume ingredients.

12. A bactericidal perfume composition according to claim 11 wherein the bactericidal perfume ingredients are selected from: Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline, 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Cinnamon leaf oil, Fucus oil, Palmarosa oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof.

13. A method of providing rapid bactericidal consumer product formulations which comprises the steps of: providing one or more perfume ingredients selected from:
Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol (E)-2-(3,3-dimethylbicyclo[2.2.1]hept-2-ylidene)-ethanol, 3,7-dimethyl-7-octen-1-ol 2-methyl-5-phenyl-pentanol, Carvacrol, 2-methoxy-4-propyl-phenol, Eugenol Thymol 4-tert-pentyl-cyclohexanone, 2-(1-methylpropyl)-cyclohexanone, 6-isopropylquinoline, 8-isopropylquinoline 3-(4-methyl-3-cyclohexenyl)-butanol Dihydromyrcenol, 8-(1-methylethyl)-1-oxaspiro[4.5]-decan-2-one, Menthol 6-hexyltetrahydro-2H-pyran-2-one 4-(1,1-dimethylethyl)-cyclohexanol, 5-hexyl-furan-2(3H)-one, Geranium oil, Cinnamon leaf oil Fucus oil, Palmarosa oil, Origanum oil 3,5-dimethyl-cyclohex-3-en-1-carboxaldehyde, Citral, 4-methyl-phenyl-acetaldehyde Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof and admixing said perfume ingredients with the (b) hydrotrope and (c) surfactant according to claim 1.

14. A method of providing rapid bactericidal consumer product formulations which comprises the steps of: providing one or more perfume ingredients selected from:
Geraniol, 3-methyl-5-phenyl-pentanol, dec-9-en-1-ol, octan-1-ol, nonan-1-ol, cuminic alcohol, perillic alcohol, Citronellol, 4-(1-methylethyl)-cyclohexanol, 2,2-dimethyl-3-(3-methyl phenyl)-propanol, 4-(1-methylethyl)cyclohexyl-methanol, Nerol, (E)-2-(3,3-dimethylbicyclo[2.2.1]hept-2-ylidene)-ethanol, 3,7-dimethyl-7-octen-1-ol, 2-methyl-5-phenyl-pentanol, Carvacrol, 2-methoxy-4-propyl-phenol, Eugenol, Thymol, 4-tert-pentyl-cyclohexanone, 2-(1-methylpropyl)-cyclohexanone, 6-isopropylquinoline 8-isopropylquinoline, 3-(4-methyl-3-cyclohexenyl)-butanol, Dihydromyrcenol, 8-(1-methylethyl)-1-oxaspiro[4.5]-decan-2-one, Menthol, 6-hexyltetrahydro-2H-pyran-2-one, 4-(1,1-dimethylethyl)-cyclohexanol, 5-hexyl-furan-2(3H)-one, Geranium oil, Cinnamon leaf oil, Fucus oil, Palmarosa oil, Origanum oil, 3,5-dimethyl-cyclohex-3-en-1-carboxaldehyde, Citral, 4-methyl-phenyl-acetaldehyde, Borneol, 6-(1-methylpropyl)-quinoline, 2,4-dimethyl-3-cyclohexenecarboxaldehyde, dihydroterpineol, 3-methyl-5-phenyl-pentanal, 5-hexyldihydro-5-methyl-2(3H)-furanone, 1-(2-naphthalenyl)-ethanone, 5-heptyldihydro-2(3H)-furanone, 5-methyltricyclo[6.2.1.02,7]undecan-4-one, 2,6-dimethylheptan-2-ol, 3,7-dimethyl-nona-1,6-dien-3-ol, and Tetrahydrolinalool, or combinations thereof, and admixing said perfume ingredients with (d) one or more agents active against gram-positive bacteria and (e) one or more chelating agents selected from the group consisting of EDTA, and CDTA according to claim 2.

15. A method according to claim 14 wherein (d) the one or more agents active against gram-positive bacteria is a selected from: a phenolic compound, o-Phenyl-phenol, a chlorinated phenolic compound, 2-benzyl-4-chlorphenol, Triclosan, or combinations thereof.

16. A method according to claim 15 wherein (d) the one or more agents active against gram-positive bacteria is present in a concentration of 0.02 to 0.5% (w/v).
